(19) United States
(12) Patent Application Publication
(10) Pub. No.: US 2002/0178874 A1
(43) Pub. Date: Dec. 5, 2002

(54) Intermediate member for connecting with tools

(76) Inventor: Hsiu-Yueh Lee, Taichung (TW)

Correspondence Address: Mr. Phillip LIU, 6980 Whiteoak Dr., Richmond, BC, V7E 4Z9, CA

(21) Appl. No.: 09/866,267

(22) Filed: May 30, 2001

(51) Int. Cl. B25B 23/16

(52) U.S. Cl. 81/177.2

(57) ABSTRACT

An intermediate member includes a tubular body having a hexagonal cross section and a passage is defined through the body. An annular flange extends radially inward from an inner periphery of the passage and encloses a hole. The passage includes a hexagonal section which is ended at a first side of the annular flange, and a square section which is ended at a second side of the flange. Different types of tools can be cooperated with the hexagonal section, the square section, or the hexagonal outside of the intermediate member.

### FIELD OF THE INVENTION

The present invention relates to an intermediate member having a hexagonal cross section and a passage defined through the intermediate member. A hexagonal opening and a square opening are respectively defined in two ends of the intermediate member so as to be connected with other tools or bits.

### BACKGROUND OF THE INVENTION

A conventional intermediate member is shown in FIG. 1 and generally includes a tubular body with circular cross section and a hexagonal or square recess 12 is defined in a first end of the body and an engaged end 11 located on a second end of the body. A bit with a hexagonal or square outside can be engaged with the recess 12, and a sleeve can be mounted to the engaging end 11. The intermediate member can be cooperated with a ratchet tool which has an rotatable engaging shaft engageable with the recess 12 so that when rotating the ratchet tool, the intermediate member is rotated. Because of the circular cross section of the body, the intermediate member cannot clamped by a wrench to assist it to rotate. The conventional intermediate member can only cooperate with limited types of tools and is not satisfied by the users.

The present invention intends to provide an intermediate member that can be cooperated with wrenches, bits, and ratchet tools with engaging shaft.

### SUMMARY OF THE INVENTION

In accordance with one aspect of the present invention, there is provided an intermediate member and comprises a tubular body having a hexagonal cross section and a passage is defined through the body. An annular flange extends radially inward from an inner periphery of the passage and encloses a hole. The passage is divided into a first section having a hexagonal inner periphery and a second section having a square inner periphery by the annular flange.

The primary object of the present invention is to provide an intermediate member which is able to be cooperated with bits, ratchet tools, wrench and/or sleeves.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a plan view to show a conventional intermediate member;

FIG. 2 is a perspective view to show the intermediate member of the present invention;

FIG. 3 is a cross sectional view to show the intermediate member of the present invention;

FIG. 4 is an illustrative view to show the intermediate member of the present invention cooperated with a bit and a ratchet tool;

FIG. 5 is an illustrative view to show the intermediate member of the present invention cooperated with a bit and sleeve connected with a ratchet tool;

FIG. 6 is an illustrative view to show the intermediate member of the present invention cooperated with a bit and sleeve connected with a ratchet tool, a wrench is clamped on the intermediate member;

FIG. 7 is an illustrative view to show the intermediate member of the present invention cooperated with a bit and a handle, and

FIG. 8 is an illustrative view to show a wrench is clamped on the intermediate member when the intermediate member is connected with the handle.

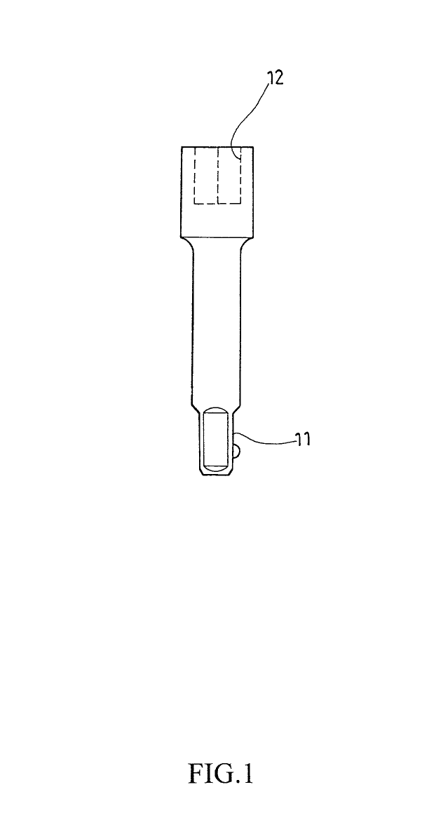

### DETAILED DESCRIPTION OF THE PREFERRED EMBODIMENT

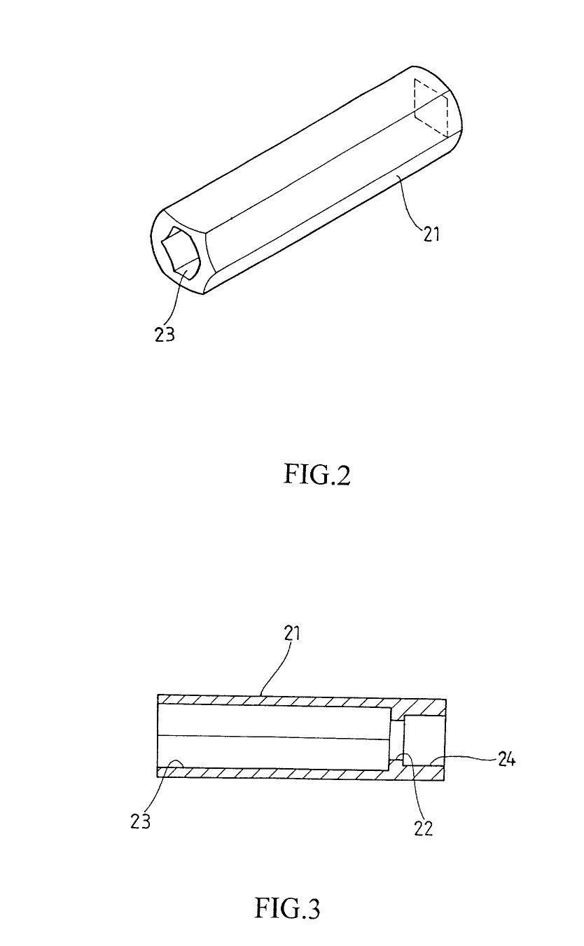

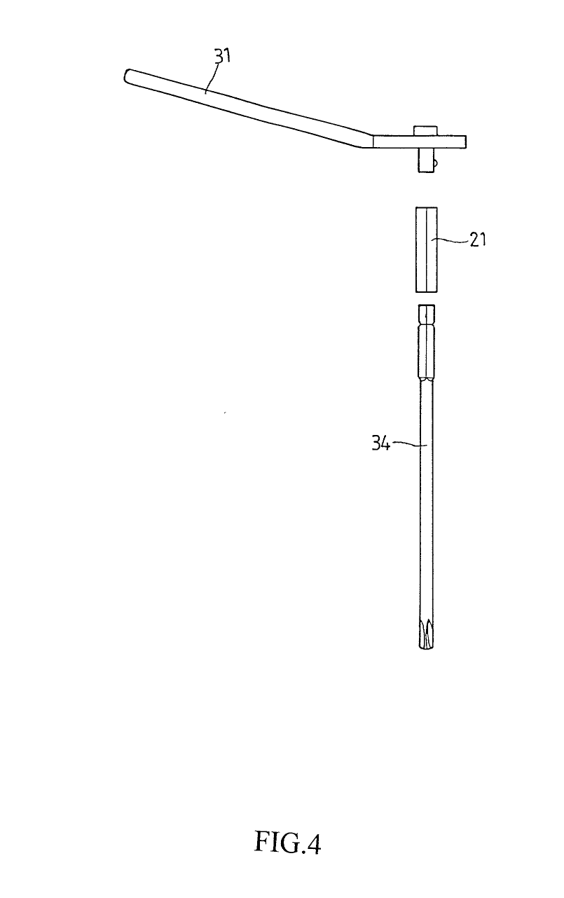

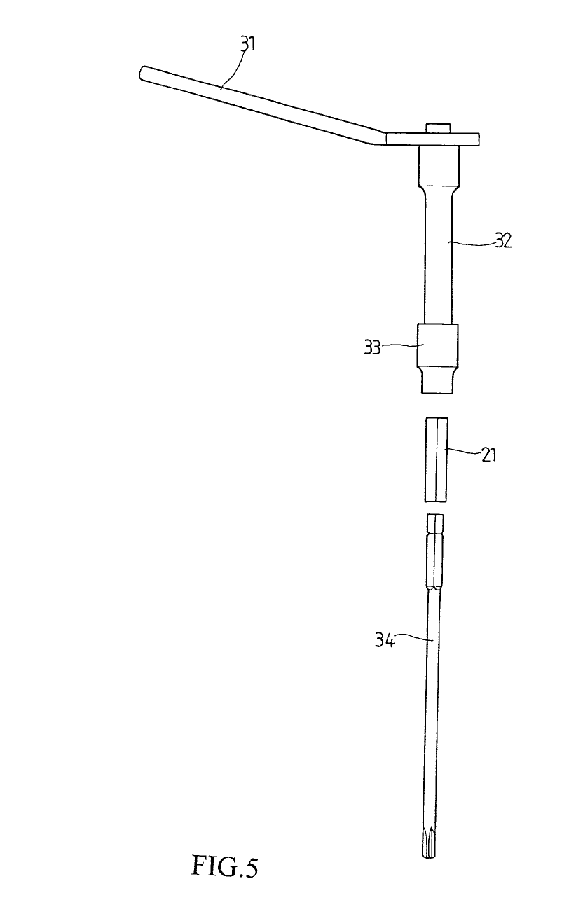

Referring to FIGS. 2 and 3, the intermediate member of the present invention comprises a tubular body 21 having a hexagonal cross section and a passage 20 is defined through the body 21. An annular flange 22 extends radially inward from an inner periphery of the passage 20 and encloses a hole 220. The passage 20 is divided the passage 20 into a first section 23 and a second section 24 by the annular flange 22. The first section 23 has a hexagonal inner periphery and is ended at a first side of the annular flange 22. The second section 24 has a square inner periphery and is ended at a second side of the annular flange 22. A length of the first section 23 is longer than a length of the second section 24. The longer first section 23 ensures the connection of a bit 34 as shown in FIG. 4 is firmly engaged in the first section 23. The hole 220 allows a longer bit received in the intermediate member 21 by extending the bit through the hole 220.

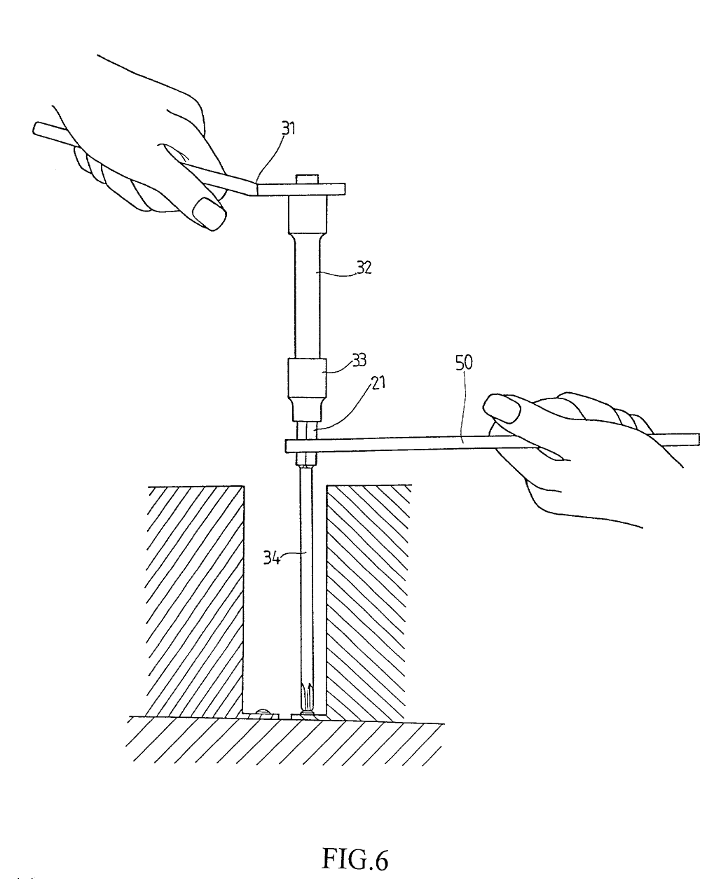

As shown in FIG. 4, the second section 24 is used to receive an engaging shaft of a ratchet tool 31, and the first section 23 is used to engage with the bit 34. The bit 34 is then rotated by rotating the ratchet tool 31. FIG. 5 shows that an extension rod 32 is connected to the ratchet tool 31 and a sleeve 33 is connected with the extension rod 32. The intermediate member 21 is engaged with the sleeve 33 and the bit 34 is engaged with the first section 23. By this arrangement, the bit 34 is able to reach a deeper position as shown in FIG. 6, wherein a wrench 50 clamps the hexagonal outside of the intermediate member 21 to assist rotation of the intermediate member 21.

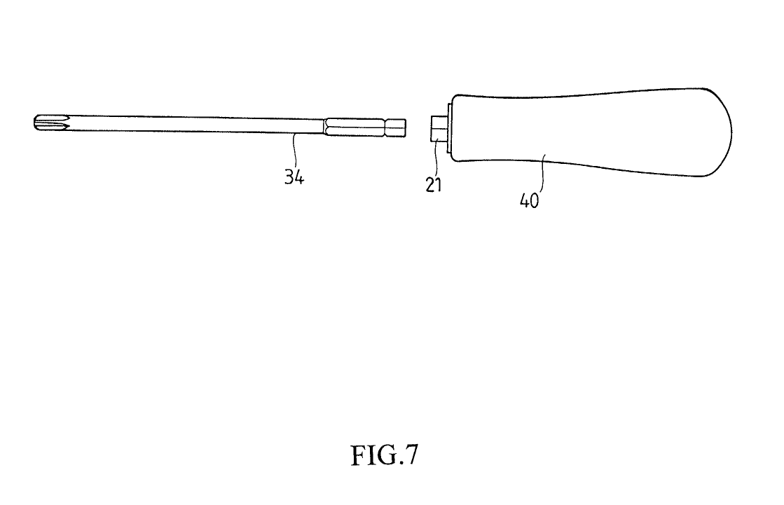

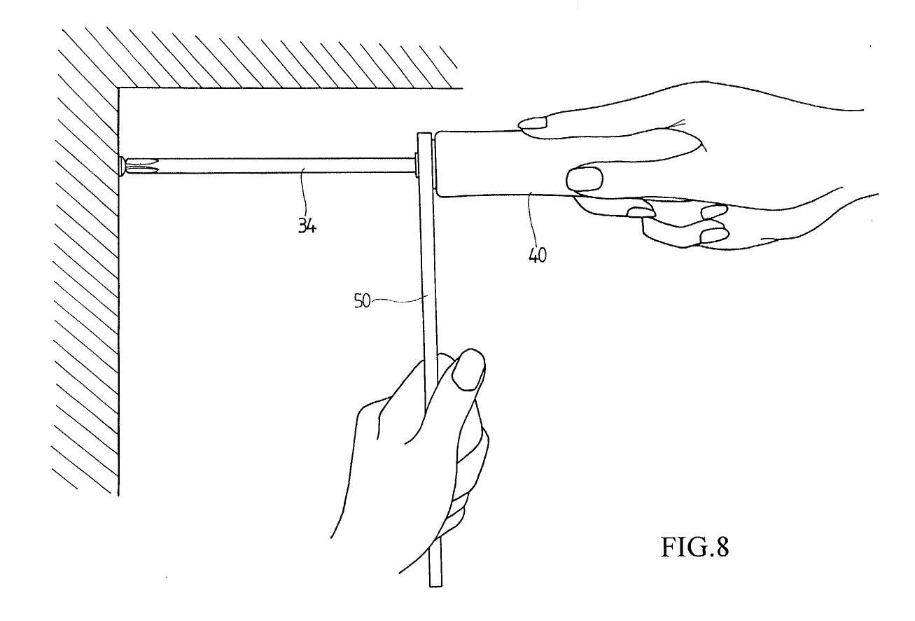

FIGS. 7 and 8 show the intermediate member 21 can be received in a handle 40 and the bit 34 is engaged with the intermediate member 21. The wrench 50 clamps the hexagonal outside of the intermediate member 21 to assist rotation of the intermediate member 21.

While we have shown and described various embodiments in accordance with the present invention, it should be clear to those skilled in the art that further embodiments may be made without departing from the scope of the present invention.

What is claimed is:

1. An intermediate member comprising:
a tubular body having a hexagonal cross section and a passage defined through said body, an annular flange extending radially inward from an inner periphery of said passage and enclosing a hole, said passage having a first section which has a hexagonal inner periphery and is ended at a first side of said annular flange, and a second section which has a square inner periphery and is ended at a second side of said annular flange.

2. The intermediate member as claimed in claim 1, wherein a length of said first section is longer than a length of said second section.
